(19) United States
(12) Patent Application Publication
(10) Pub. No.: US 2014/0060984 A1
(43) Pub. Date: Mar. 6, 2014

(54) Integrally-Formed Heat-Dissipating Brake Pad Structure

(71) Applicants: Chien Jung Tseng, Changhua City (TW); Ya Cheng Huang, Lukang Township (TW); Yuan Yu Liao, Taichung City (TW)

(72) Inventors: Chien Jung Tseng, Changhua City (TW); Ya Cheng Huang, Lukang Township (TW); Yuan Yu Liao, Taichung City (TW)

(21) Appl. No.: 13/674,660

(22) Filed: Nov. 12, 2012

(30) Foreign Application Priority Data
Aug. 30, 2012 (TW) 101216707

(51) Int. Cl. F16D 65/847; F16D 65/092

(52) U.S. Cl. CPC F16D 65/847; F16D 65/092
USPC 188/251 R

(57) ABSTRACT

An integrally-formed heat-dissipating brake pad structure, wherein the structure includes a backing plate, with a first side and a second side arranged back to back with respect to one another; a brake pad, mounted on the first side; and a plurality of heat dissipating parts, integrally and outwardly extended from the second side, so that heat generated by the friction of the brake pad during a brake can be dissipated by the integrally formed backing plate and heat dissipating parts.

### BACKGROUND OF THE INVENTION

This application claims the benefit of foreign application TW 101216707, filed in Taiwan on Aug. 30, 2012, the entire specification of which is incorporated by reference.

1. Field of the Invention

The present invention relates to a brake pad structure, and more particularly to an integrally formed heat dissipating brake pad.

2. Description of Related Art

With reference to FIG. 4 for a conventional brake pad structure 6, the brake pad structure 6 is mounted on a brake caliper 7, and the brake pad 61 is installed on a metal backing plate 62 and disposed opposite to another set of brake pad 6′, and a brake disc 8 is installed between two brake pads 61, 61′, and driven by a hydraulic cylinder 71, 71′ to drive the metal backing plates 62, 62′ to approach each other, so that the brake pads 61, 61′ can clamp the brake disc 8 to retard the rotation speed of the tire, and the brake pads 61, 61′ generate heat due to the friction produced during the process of clamping the brake disc 8, so that the temperature of the brake disc 8 is increased, and the braking performance may be affected. Therefore, a heat sink is required for dissipating the heat in order to prevent accidents occurred during the brake.

### SUMMARY OF THE INVENTION

It is a main objective of the present invention to provide an integrally-formed heat-dissipating brake pad structure, wherein a backing plate is moved towards a side of a plurality of integrally-formed heat dissipating parts and provided for quickly dissipating the heat generated by the brake pad during a brake.

To achieve the aforementioned objective, the present invention provides an integrally-formed heat-dissipating brake pad structure comprising a backing plate with a first side and a second side arranged back to back with respect to one another; a brake pad mounted on the first side; and a plurality of heat dissipating parts integrally and outwardly extended from the second side.

### BRIEF DESCRIPTION OF THE DRAWINGS

FIG. 1 is a perspective view of the present invention;

FIG. 2 is a side view of the present invention;

FIG. 3 is a schematic view of a using status of the present invention mounted on a brake caliper; and

FIG. 4 is a schematic view of a using status of a conventional brake pad.

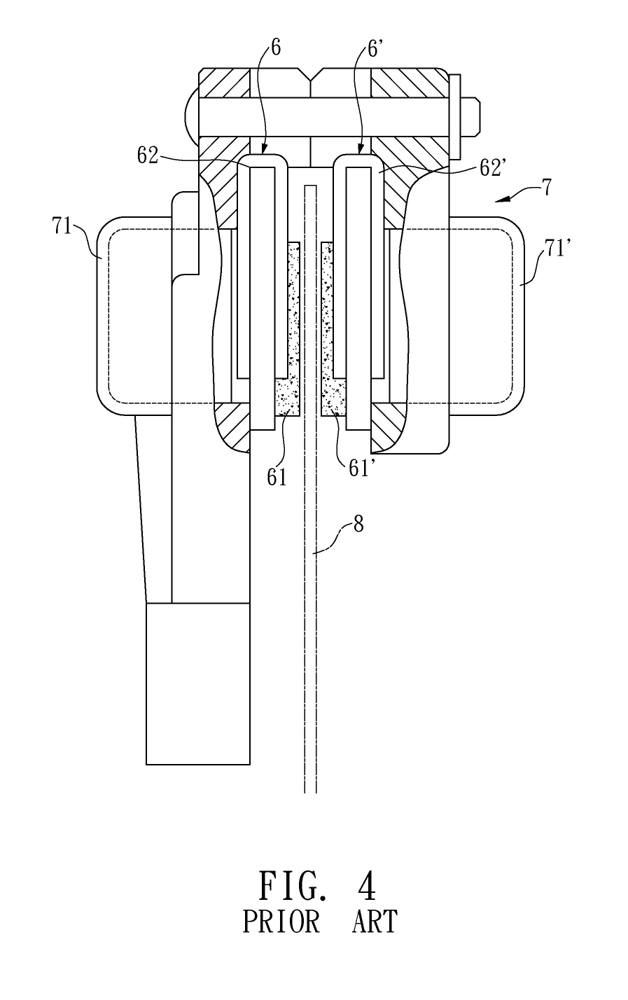

### DETAILED DESCRIPTION OF THE PREFERRED EMBODIMENTS

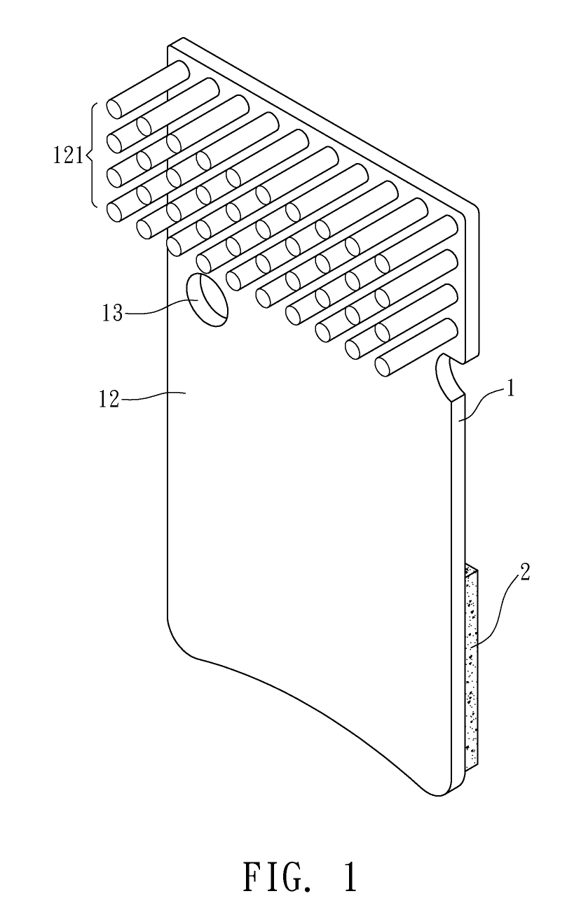

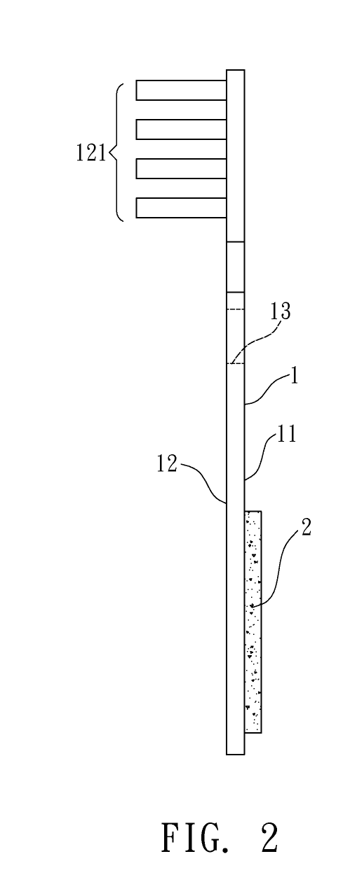

With reference to FIGS. 1 and 2 for an integrally-formed heat-dissipating brake pad structure of the present invention, the structure comprises a backing plate 1 made of metal for conducting heat easily, and the backing plate 1 has a first side 11 and a second side 12 arranged back to back with respect to one another, wherein a brake pad 2 is mounted onto the first side 11, and a plurality of heat dissipating parts 121 is integrally and outwardly extended from the second side 12, and the backing plate 1 has a positioning hole 13 penetrated through the backing plate 1 and provided for installing and positioning the brake caliper (not shown in the figure). In this preferred embodiment, the brake pad 2 is installed at the bottom of the first side 11, and the heat dissipating parts 121 are distributed at the top of the second side 12, wherein the heat dissipating parts 121 are cylindrical bodies outwardly extended from the backing plate for expanding the heat dissipating area to enhance the heat dissipating efficiency.

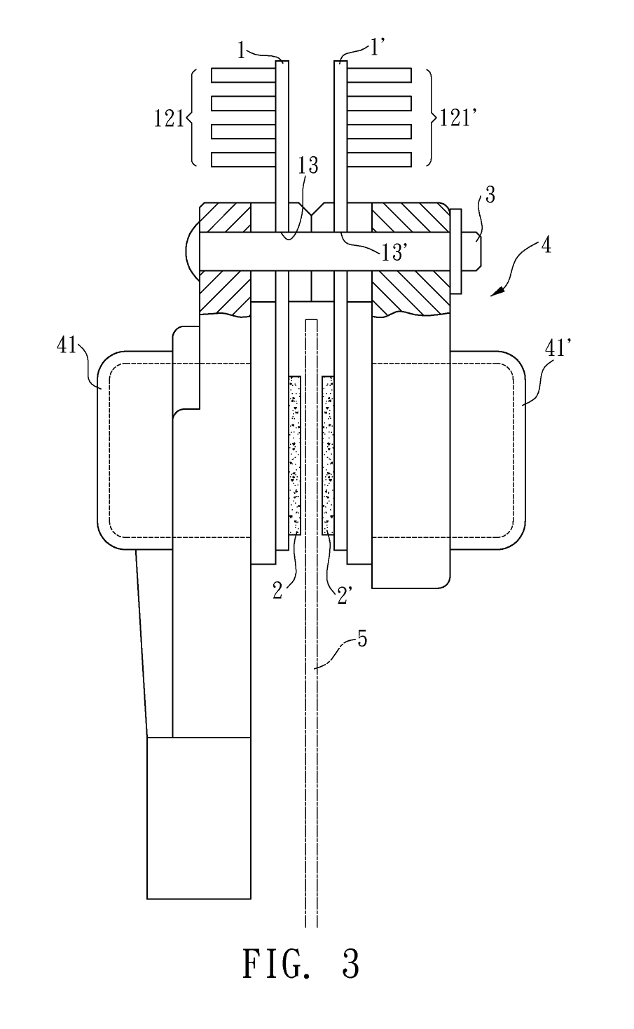

With reference to FIG. 3 for a practical application of the present invention, two sets of brake pad structures are used, wherein two brake pads 2, 2′ are installed in opposite directions to one another, and a positioning element 3 is passed through the positioning hole 13, 13′ of the backing plate 1, 1′ and fixed onto a brake caliper 4. In addition, the brake caliper 4 has two hydraulic cylinders 41, 41′ installed on the backing plates 1, 1′ of the two sets of the brake pad structures respectively for driving the two backing plate 1, 1′ to approach one another, so that the two backing plates 1, 1′ together with the brake pad 2, 2′ can be approached to one another, and the brake disc 5 clamped at the tire can retard the rotation speed of the tire. Now, the brake pads 2, 2′ clamped at the brake disc 5 generate a large quantity of heat due to the friction, and the heat can be conducted and dissipated to the outside quickly through the integrally formed heat dissipating parts 121, 121′ and made of the same material of the backing plate 1, 1′. With the design of the present invention, the risk of having accidents caused by the rise of temperature during a brake can be minimized.

What is claimed is:

1. An integrally-formed heat-dissipating brake pad structure, comprising:
a backing plate, with a first side and a second side arranged back to back with respect to one another;
a brake pad, mounted on the first side; and
a plurality of heat dissipating parts, integrally and outwardly extended from the second side.

2. The integrally-formed heat-dissipating brake pad structure of claim 1, wherein the heat dissipating part is a cylindrical body.

3. The integrally-formed heat-dissipating brake pad structure of claim 1, wherein the backing plate has a positioning hole penetrating through the backing plate for installing and positioning a brake caliper.

4. The integrally-formed heat-dissipating brake pad structure of claim 1, wherein the brake pad is installed at the bottom of the first side of the backing plate, and the heat dissipating parts are distributed at the top of the second side of the backing plate.
